(19) United States
(12) Patent Application Publication
(10) Pub. No.: US 2006/0287789 A1
(43) Pub. Date: Dec. 21, 2006

(54) Multimedia device for cars

(76) Inventor: Hsiang-Chi Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/452,194

(22) Filed: Jun. 14, 2006

(30) Foreign Application Priority Data
Jun. 17, 2005 (TW) 094210265

(51) Int. Cl. G06F 7/00

(52) U.S. Cl. 701/36; 701/1

(57) ABSTRACT

A multimedia device for cars is provided, including a player data bus, a player I/O interface, a microprocessor, a memory unit, a USB controller, a buffer, and an MHE. The player data bus and player I/O interface are connected to a multimedia player for cars. The multimedia player for cars is an audiovisual player. The microprocessor controls the data input/output and the storage of the player. The USB controller, the buffer, and the MHE form a USB connection and transmission interface. The multimedia device of the present invention is a connected to a USB connector and a card reader interface through the USB controller and the MHE, respectively. Therefore, the multimedia device can be connected to a multimedia storage device with a USB interface or a flash memory for access.

### BACKGROUND OF THE INVENTION

1. Field of the Invention

The present invention relates to a multimedia device for cars and, more particularly, to a multimedia device applicable to audiovisual players used in cars. The multimedia device is to play media data, download and store media data.

2. The Related Art

Cars are the most popular transportation vehicles in many places. As the development of the cars, more and more drivers consider that an audiovisual device an indispensable part of a car.

Conventional audiovisual players for cars, such as DVD, VCD or cassette players, are only for playing pre-recorded media storages, such as DVD disk, VCD disk, video or audio tapes. Conventional audiovisual players for cars cannot be used with other multimedia devices, such as MP3 player, flash memory sticks, notebook computers, mobile phones, PDA, digital camera, recording pen, and so on. Therefore, the functions provided by audiovisual devices for cars are limited, and fail to meet the standard of the multimedia entertainment for the car users. As the multimedia devices for households and offices are rapidly developed, it is important to further the development of multimedia devices for cars.

### SUMMARY OF THE INVENTION

A primary object of the present invention is to provide a multimedia device for cars, including a player data bus, a player I/O interface, a microprocessor, a memory unit, a USB controller, a buffer, and an MHE. The player data bus and player I/O interface are connected to a multimedia player for cars. The multimedia player for cars is an audiovisual player. The microprocessor controls the data input/output and the storage of the player. The USB controller, the buffer, and the MHE form a USB connection and transmission interface. The multimedia device of the present invention is connected to a USB connector and a card reader interface through the USB controller and the MHE, respectively. Therefore, the multimedia device of the present invention can be connected to a multimedia storage device with a USB interface or a flash memory for access.

The present invention improves the limitation experienced by conventional audiovisual players for cars that can only be used for playing pre-recorded storage media. The present invention can be used with popular digital devices, such as MP3 player, flash memory stick, notebook computer, mobile phone, PDA, digital camera, recording pen, and so on. Therefore, the audiovisual data stored on these digital devices can be played on the audiovisual player for cars. In addition, the audiovisual data in the audiovisual player for cars can be downloaded and stored in these digital devices.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a system block diagram of a first embodiment of the present invention; and

FIG. 2 is a system block diagram of a second embodiment of the present invention.

### DETAILED DESCRIPTION OF THE PREFERRED EMBODIMENT

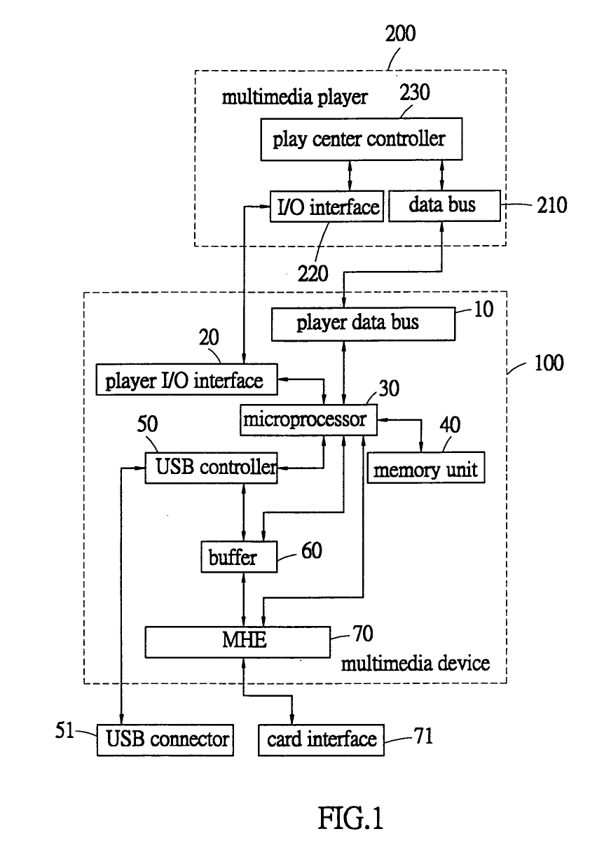

With reference to the drawings and in particular to FIG. 1, which shows a first embodiment of the present invention, a multimedia device 100 for cars includes a player data bus 10, a player I/O interface 20, a microprocessor 30, a memory unit 40, a USB controller 50, a buffer 60, and an MHE 70. The player data bus 10 and the player I/O interface 20 are connected, respectively, to a data bus 210 and an I/O interface 220 of a multimedia player 200 for cars. The multimedia player 200 is not limited to any specific type. The embodiment uses a DVD player as an example. But a VCD player for an audio tape player can also be used.

The multimedia player 200 includes a play center controller 230 for controlling the playing of the DVD media. The data bus 210 and the I/O interface 220 are connected to the play center controller 230 so that the play center controller 230 controls data input/output. The control and the circuitry of the play center controller 230 on the data bus 210 and the I/O interface 220 are of conventional technology, and will be omitted here.

The player data bus 10 and the player I/O interface 20, through the connection to the data bus 210 and the I/O interface 20, are connected to the play center controller 230 for bi-directional data transmission.

The microprocessor 30 controls the transmission and storage of the media data. The microprocessor 30 is pre-installed with programs for controlling the format conversion, transmission, and storage of the media data. The microprocessor 30 is connected to the player data bus 10 and the player I/O interface 20. Through the player data bus 10 and the player I/O interface 20, the microprocessor 30 can receive data from or transmit data to the play center controller 230 of the multimedia player 200.

The memory unit 40 is connected to the microprocessor 30 to provide the temporary storage for the data or program. The memory unit 40 is not limited to any specific type. This embodiment uses SDRAM as an example.

The USB controller 50, the buffer 60, and the MHE 70 serially form a USB interface. The USB controller 50, the buffer 60, and the MHE 70 are connected and controlled by microprocessor 30, respectively. The USB controller 50 is connected to a USB connector 51, which provides connections to a multimedia device with a USB interface, such as MP3 player, flash memory stick, notebook computer, mobile phone, PDA, digital camera, recording pen, and so on. Through the USB controller 50, the multimedia device with a USB interface can transmit the audiovisual data, through the microprocessor 30, the player data bus 10, the player I/O interface 20, to the play center controller 230 of the multimedia player 200 for processing and playing. Conversely, the audiovisual data in the play center controller 230 can be downloaded and stored in the multimedia device with a USB interface.

The buffer 60 provides the temporary storage to buffer data when the amount of data is large. The buffer 60 is connected to the MHE 70, so that the MHE 70 becomes a card-reading interface. The MHE 70 is connected to a card interface 71, through which the connection to a flash memory card is provided. A flash memory card connected to the card interface 71 can transmit the audiovisual data to the play center controller 230 of the multimedia player 200, through the MHE 70, the microprocessor 30, the player data bus 10, and the player I/O interface 20, for processing and playing. Conversely, the audiovisual data in the play center controller 230 can be downloaded and stored in the flash memory card through the aforementioned path.

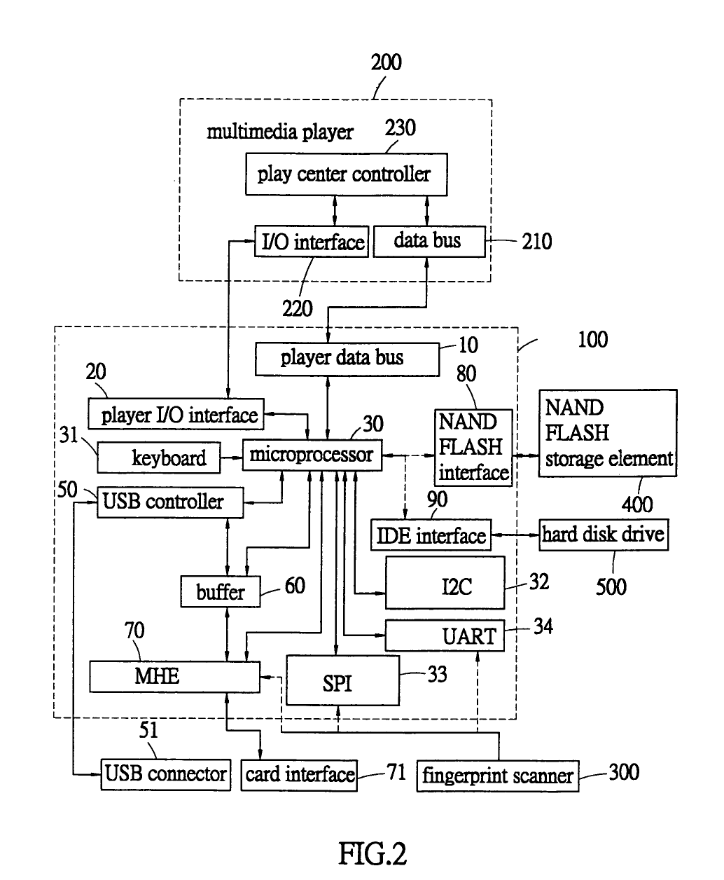

FIG. 2 shows the second embodiment of the present invention. The memory unit 40 stores the image data of the fingerprints of the user. The microprocessor 30 is connected to a keyboard 31, an I2C 32, an SPI 33, an UART 34, a NAND FLASH interface 80, and an IDE interface 90. The keyboard 31 provides the instruction input to the microprocessor 30, such as uploading for playing or downloading for storage.

As shown in FIG. 2, the I2C 32, the SPI 33, and the UART 34 serially form a structure for image data transmission. The SPI 33 and the UART 34 are connected to a fingerprint scanner 300 to input the fingerprint image data for comparison against the pre-stored fingerprint image data in the memory unit 40. The microprocessor 30 performs the comparison and determines whether to activate the uploading and downloading functions. This provides the locking and unlocking mechanism of the device.

The NAND FLASH interface 80 and the IDE interface 90 provide connections to a NAND FLASH storage element 400 and a hard disk drive 500, respectively. Through the microprocessor 30 and the USB controller 50, bi-directional data transmission to the multimedia devices connected to the USB connector 51 can be executed. For example, the GPS map can be uploaded to a flash memory stick with the USB interface. Similarly, through the microprocessor 30, the buffer 60, the MHE 70, and the card interface 71, the bi-directional data transmission can also be performed between the NAND FLASH storage element 400, the hard disk drive 500, and the flash memory card connected to the card interface 71.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A multimedia device for cars, applicable to a multimedia player used in cars, the multimedia device comprising:
a player data bus, connected to a data bus to the multimedia player;
a player I/O interface, connected to an I/O interface of the multimedia player;
a microprocessor, connected to the player data bus and the player I/O interface, forming bi-directional data transmission connection with the multimedia player through the player data bus and the player I/O interface, being able to perform the format conversion, transmission and storing of data;
a memory unit, connected to the microprocessor to provide temporary storage of data and programs to the microprocessor;
a USB controller, connected to the microprocessor, and connected externally to a digital multimedia device having an USB interface, for bi-directional data transmission between the external digital multimedia device and the multimedia player;
a buffer, connected to the microprocessor and the USB controller to provide temporary storage; and
an MHE, connected to the buffer and the microprocessor, and connected externally to a flash memory card for providing bi-directional data transmission between the external flash memory card and the multimedia player.

2. The device as claimed in claim 1, wherein the microprocessor is connected to a keyboard.

3. The device as claimed in claim 1, wherein the microprocessor is connected to an I2C, an SPI and an UART.

4. The device as claimed in claim 3, wherein the SPI and the UART are connected to a fingerprint scanner.

5. The device as claimed in claim 1, wherein the microprocessor is connected to a NAND FLASH interface and an IDE interface.

6. The device as claimed in claim 5, wherein the NAND FLASH interface is connected to a NAND FLASH storage element.

7. The device as claimed in claim 5, wherein the IDE interface is connected to a hard disk drive.

8. The device as claimed in claim 1, wherein the memory unit is an SDRAM.

9. The device as claimed in claim 1, wherein the USB controller is connected to a USB connector.

10. The device as claimed in claim 1, wherein the MHE is connected externally to a card interface.
